(19) United States
(12) Patent Application Publication
(10) Pub. No.: US 2013/0002708 A1
(43) Pub. Date: Jan. 3, 2013

(54) METHOD, APPARATUS, AND COMPUTER PROGRAM PRODUCT FOR PRESENTING INTERACTIVE DYNAMIC CONTENT IN FRONT OF STATIC CONTENT

(75) Inventors: Hayes Raffle, Palo Alto, CA (US); Koichi Mori, San Jose, CA (US); Rafael Ballagas, Palo Alto, CA (US); Hiroshi Horii, Palo Alto, CA (US); Mirjana Spasojevic, Palo Alto, CA (US); Glenda Revelle, Fayetteville, AR (US)

(73) Assignee: Nokia Corporation, Espoo (FI)

(21) Appl. No.: 13/175,713

(22) Filed: Jul. 1, 2011

(51) Int. Cl. G09G 5/00

(52) U.S. Cl. 345/619

(57) ABSTRACT

Provided herein is a technique by which static content may be presented in an underlying relationship to dynamic content. An example method may include providing for display of static content and providing for display of dynamic content, where the static content may be displayed in an underlying relationship relative to the dynamic content. The dynamic content may be responsive to a user input and the dynamic content may change in response to a change in the static content. The dynamic content may include a dynamic content response where the dynamic content response is selected from a plurality of available dynamic content responses. The static content may include an image of a page of a book and the dynamic content may include an animated character configured to read the page of the book.

### TECHNOLOGICAL FIELD

Some example embodiments of the present invention relate generally to apparatuses configured to provide for display of content and, more particularly, to a method, apparatus, and computer program product configured to present an interactive dynamic content in the foreground of a static image.

### BACKGROUND

The modern communications era has brought about a tremendous expansion of wireline and wireless networks. Computer networks, television networks, and telephony networks are experiencing an unprecedented technological expansion fueled by consumer demands. Together with these expanding network capabilities and communication speeds, the devices that use these networks have experienced tremendous technological steps forward in capabilities, features, and user interface technology. Devices communicating via these networks may be used for a wide variety of purposes including, among other things, presentation of images of pages of books, magazines, newspapers, or other printed or published materials, Short Messaging Services (SMS), Instant Messaging (IM) service, E-mail, voice calls, music recording/playback, video recording/playback, and internet browsing. Such capabilities have made these devices very desirable for those wishing to stay in touch and make themselves available to others.

Electronic reading devices, or “E-readers” have become popular devices by which a user may view an image of a page presented as a printed page would be seen in a book, magazine, or newspaper. E-readers mimic the presentation of printed materials to provide the user a more nostalgic or familiar medium in which books, magazines, or newspapers may be read. While E-readers provide a familiar medium mimicking printed materials, E-readers suffer from several drawbacks including lacking an interactive feel that may be desirable to younger, more technologically savvy readers, such as children.

### BRIEF SUMMARY

A method, apparatus and computer program product are provided to enable an apparatus, such as an electronic reading device, to display interactive dynamic content in front of static content. As such, the user experience for the user of an electronic reading device may be enhanced with an animated character configured to interact with a reader.

An example embodiment may provide a method including providing for display of static content and providing for display of dynamic content, where the static content may be displayed in an underlying relationship relative to the dynamic content. The dynamic content may be responsive to a user input. The method may further include causing a change of the dynamic content in response to a change in the static content. The dynamic content may include a dynamic content response where the dynamic content response is selected from a plurality of available dynamic content responses. The dynamic content response may be selected from a look-up table based on the displayed static content. The dynamic content response may be selected from a look-up table based on an input received from a user. The dynamic content response may be selected randomly from the available dynamic content responses. The dynamic content response may be selected deterministically from the available dynamic content responses. The static content may include an image of a page of a book and the dynamic content may include an animated character configured to read the page of the book.

Another example embodiment may provide an apparatus including at least one processor and at least one memory including computer program code, the at least one memory and the computer program code configured to, with the processor, cause the apparatus to at least provide for display of static content and provide for display of dynamic content, where the static content is presented in an underlying relationship relative to the dynamic content. The dynamic content may be responsive to a user input. The apparatus may further cause a change of the dynamic content in response to a change in the static content. The dynamic content may include a dynamic content response and the dynamic content response may be selected from a plurality of available dynamic content responses. The apparatus may be configured to select the dynamic content response from a look-up table based on the displayed static content. The apparatus may be configured to select the dynamic content response from a look-up table based on an input received from a user. The apparatus may be configured to select the dynamic content response randomly from the available dynamic content responses. The apparatus may be configured to select the dynamic content response deterministically from the available dynamic content responses. The static content may include an image of a page of a book and the dynamic content may include an animated character configured to read the page of the book.

Another example embodiment may provide a computer program product comprising at least one non-transitory computer-readable storage medium having computer-executable program code instructions stored therein, the computer-executable program code instructions comprising program code instructions to provide for display of static content and provide for display of dynamic content, where the static content is presented in an underlying relationship relative to the dynamic content. The dynamic content may be responsive to a user input. The computer program product may further include program code instructions to cause a change of the dynamic content in response to a change of the static content. The dynamic content may include a dynamic content response where the dynamic content response may be selected from a plurality of available dynamic content responses. The computer program product may further include program code instructions to select the dynamic content response from a look-up table based on the displayed static content. The computer program product may further include program code instructions to select the dynamic content response from a look-up table based on an input received from a user. The computer program product may further include program code instructions to select the dynamic content response randomly from the available dynamic content responses. The computer program product may further include program code instructions to select the dynamic content response deterministically from the available dynamic content responses. The static content may include an image of a page of a book and the dynamic content may include an animated character configured to read the page of the book.

Another example embodiment may provide an apparatus including means to provide for display of static content and means to provide for display of dynamic content, where the static content is presented in an underlying relationship relative to the dynamic content. The dynamic content may be responsive to a user input. The apparatus may further include means to cause a change of the dynamic content in response to a change in the static content. The dynamic content may include a dynamic content response and the dynamic content response may be selected from a plurality of available dynamic content responses. The apparatus may include means to select the dynamic content response from a look-up table based on the displayed static content. The apparatus may include means to select the dynamic content response from a look-up table based on an input received from a user. The apparatus may include means to select the dynamic content response randomly from the available dynamic content responses. The apparatus may include means to select the dynamic content response deterministically from the available dynamic content responses. The static content may include an image of a page of a book and the dynamic content may include an animated character configured to read the page of the book.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of an apparatus configured to facilitate shared synchronous viewing of content;

FIG. 2 is an illustration of an electronic reading device according to an example embodiment of the present invention;

FIG. 3 is an illustration of two electronic reading devices implementing a system of the present invention according to an example embodiment;

FIG. 4 is a block diagram of a system for implementing the present invention according to an example embodiment;

FIG. 5 is an illustration of an electronic reading device according to another example embodiment of the present invention;

FIG. 6 is an illustration of an electronic reading device according to still another example embodiment of the present invention; and

FIG. 7 is a flowchart diagram according to an example method for presenting static content in an underlying relationship to dynamic content according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Some embodiments of the present invention may provide for enhancements in the display of content on an apparatus which may include a mobile terminal such as an electronic reading device. Electronic reading devices, as described herein, may include apparatuses that provide for presentation of images that resemble the printed pages of a book, magazine, newspaper, or other publication. As such, users may be able to interact with electronic reading devices in a collaborative manner with another party. Embodiments of the present invention provide a platform that allows two or more parties to view content together while they are located remotely from one another. Embodiments may further allow two or more parties to see and hear each other while viewing content together. The platform may combine video conferencing technologies and shared applications to allow either party to synchronously control shared views of content.

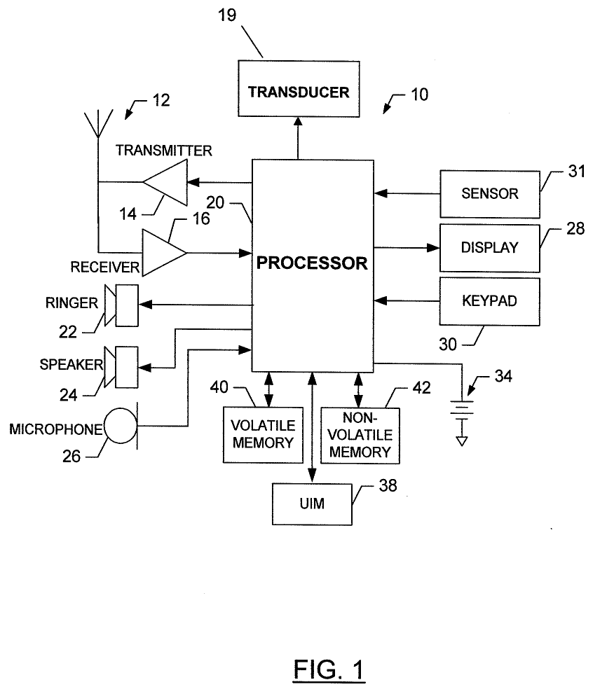

FIG. 1 illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as electronic reading devices (E-readers), portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

The mobile terminal 10 may include an antenna 12 (or multiple antennas) in operable communication with a transmitter 14 and a receiver 16. The mobile terminal 10 may further include an apparatus, such as a processor 20 or other processing device which controls the provision of signals to and the receipt of signals from the transmitter 14 and receiver 16, respectively. The signals may include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch display (display 28 providing an example of such a touch display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch display may omit the keypad 30 and any or all of the speaker 24, ringer 22, and microphone 26 entirely. Embodiments of the mobile terminal may further include a transducer 19, for example, as part of the user interface. The transducer 19 may be a haptic transducer for providing haptic feedback to a user. The haptic feedback may be provided in response to inputs received by the user or by the mobile terminal for providing tactile notification to a user.

Additional input to the processor 20 may include a sensor 31, which may be a component of the mobile terminal 10 or remote from the mobile terminal, but in communication therewith. The sensor 31 may include one or more of a motion sensor, temperature sensor, light sensor, accelerometer, or the like. Forms of input that may be received by the sensor may include physical motion of the mobile terminal 10, light impinging upon the mobile terminal, such as whether or not the mobile terminal 10 is in a dark environment (e.g., a pocket) or in daylight, and/or whether the mobile terminal is being held by a user or not (e.g., through temperature sensing of a hand). The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

In some embodiments, the mobile terminal 10 may also include a camera or other media capturing element (not shown) in order to capture images or video of objects, people and places proximate to the user of the mobile terminal 10. However, the mobile terminal 10 (or even some other fixed terminal) may also practice example embodiments in connection with images or video content (among other types of content) that are produced or generated elsewhere, but are available for consumption at the mobile terminal 10 (or fixed terminal).

The processor 20 may be embodied in a number of different ways. For example, the processor 20 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 20 may include one or more processing cores configured to perform independently. A multi-core processor may enable multiprocessing within a single physical package. Additionally or alternatively, the processor 20 may include one or more processors configured in tandem via the bus to enable independent execution of instructions, pipelining and/or multithreading.

In an example embodiment, the processor 20 may be configured to execute instructions stored in the memory device 42 or otherwise accessible to the processor 20. Alternatively or additionally, the processor 20 may be configured to execute hard coded functionality. As such, whether configured by hardware or software methods, or by a combination thereof, the processor 20 may represent an entity (e.g., physically embodied in circuitry) capable of performing operations according to an embodiment of the present invention while configured accordingly. Thus, for example, when the processor 20 is embodied as an ASIC, FPGA or the like, the processor 20 may be specifically configured hardware for conducting the operations described herein. Alternatively, as another example, when the processor 20 is embodied as an executor of software instructions, the instructions may specifically configure the processor 20 to perform the algorithms and/or operations described herein when the instructions are executed. However, in some cases, the processor 20 may be a processor of a specific device (e.g., an apparatus configured to provide for display of an image, such as an electronic reading device) adapted for employing an embodiment of the present invention by further configuration of the processor 20 by instructions for performing the algorithms and/or operations described herein. The processor 20 may include, among other things, a clock, an arithmetic logic unit (ALU) and logic gates configured to support operation of the processor 20.

At least some components of the mobile terminal 10 including the processor 20 and, in some embodiments, a memory device, such as volatile memory 40, may be embodied as a chip or chipset. In other words, processor 20 and optionally an associated memory device may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processor 20 and optionally an associated memory device may therefore, in some cases, be configured to implement an embodiment of the present invention on a single chip or as a single “system on a chip.” As such, in some cases, a chip or chipset may constitute means for performing one or more operations for providing the functionalities described herein.

Example embodiments of the present invention may be employed by people who are interested in distance-collaboration activities such as distance learning or sharing experiences and information with other people who may be located remotely from each other. For example, families with family members located in distant places that may not be able to visit one another as often as they would like may employ example embodiments of the present invention in order to engage in activities with other family members which may replicate the experience of being together. Presently people may “connect” with one another via telephone, video conference, or messaging applications to enjoy the company of one another. Embodiments of the present invention may provide a method of sharing an experience, such as reading a book or story with another person, while the participants are not with one another or “co-located.”

The term “remote” as used herein may describe a relationship between two or more people or parties that are situated apart from one another, regardless of distance. While embodiments of the present invention are described with respect to parties that are not in the same location, it should be appreciated the embodiments of the invention may be used between parties that are in the same location as one another if desired by the participating parties.

As noted above, embodiments of the present invention provide a method, apparatus, and computer program product that allows two or more parties to view content together while they are located remotely from one another. Embodiments may further allow two or more parties to see and hear each other while viewing content together combining video conferencing technologies and shared applications to allow the parties to mutually interact and collaborate with content.

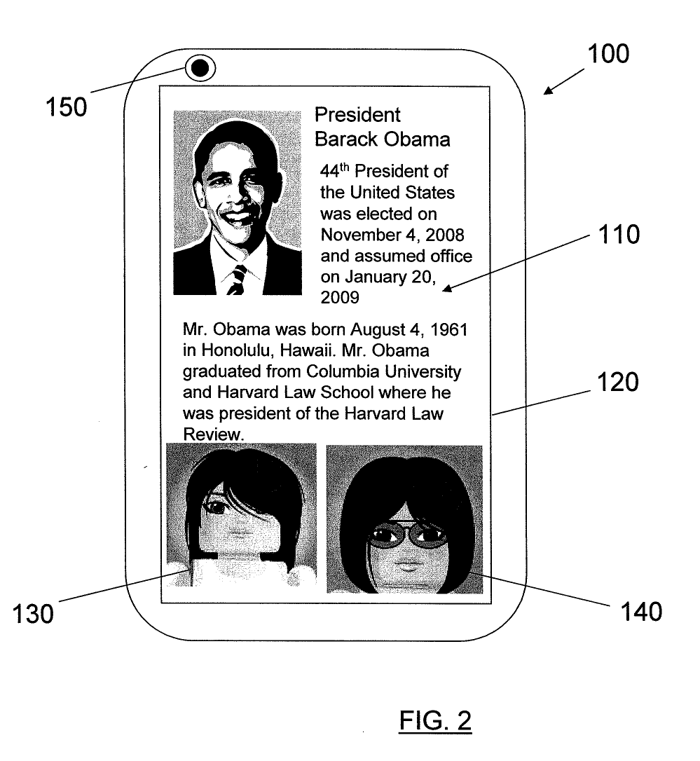

An example embodiment will be described herein with respect to FIG. 2 which depicts an electronic reading device 100 displaying content 110 on a display 120, such as display 28 of mobile terminal 10. The content 110 may be an image, such as the image of a page of a book, or any media type configured for display. When employed by example embodiments of the present invention, the content 110 may be displayed on the device of each of the participating parties and each of the parties may be able to interact and control the displayed content 110. Further, example embodiments may provide for display of an image of each of the participating parties, such as images 130, 140. The images 130, 140 may be live camera feeds from each of the respective participants' devices. In some embodiments, the device 100 may display an image of the user of the remote device 140 and an image of the user of the local device 130, such that image 130 is that of the user viewing the display 120. In such an embodiment, the device 100 may include a camera 150 configured to capture images of the user as they view the display 120. The user viewing the display 130, or the user local to that device 100, may reference the image 130 to view the image that is presented on the display of the other user's device in order to ensure that they are captured (or not captured) in the image 130. Further, the participating parties may be able to hear one another as if in a phone call providing a video-conference effect while viewing the content 110.

In addition to participating parties being able to view the same content 110 and view images of the participating parties 130, 140, each of the participating parties may be able to interact with the content displayed 110. For example, if the content displayed 110 is a page of a book, any of the participating parties may be able to turn or advance pages to the next page. Embodiments may further provide for “shared pointing” where if a first participating party uses a pointing device (such as a touch of a touch screen or a pointer or cursor operated by a pointing device) to point to a portion of the content, the other participant(s) will see an icon or image illustrating where the first participating party's pointing was directed.

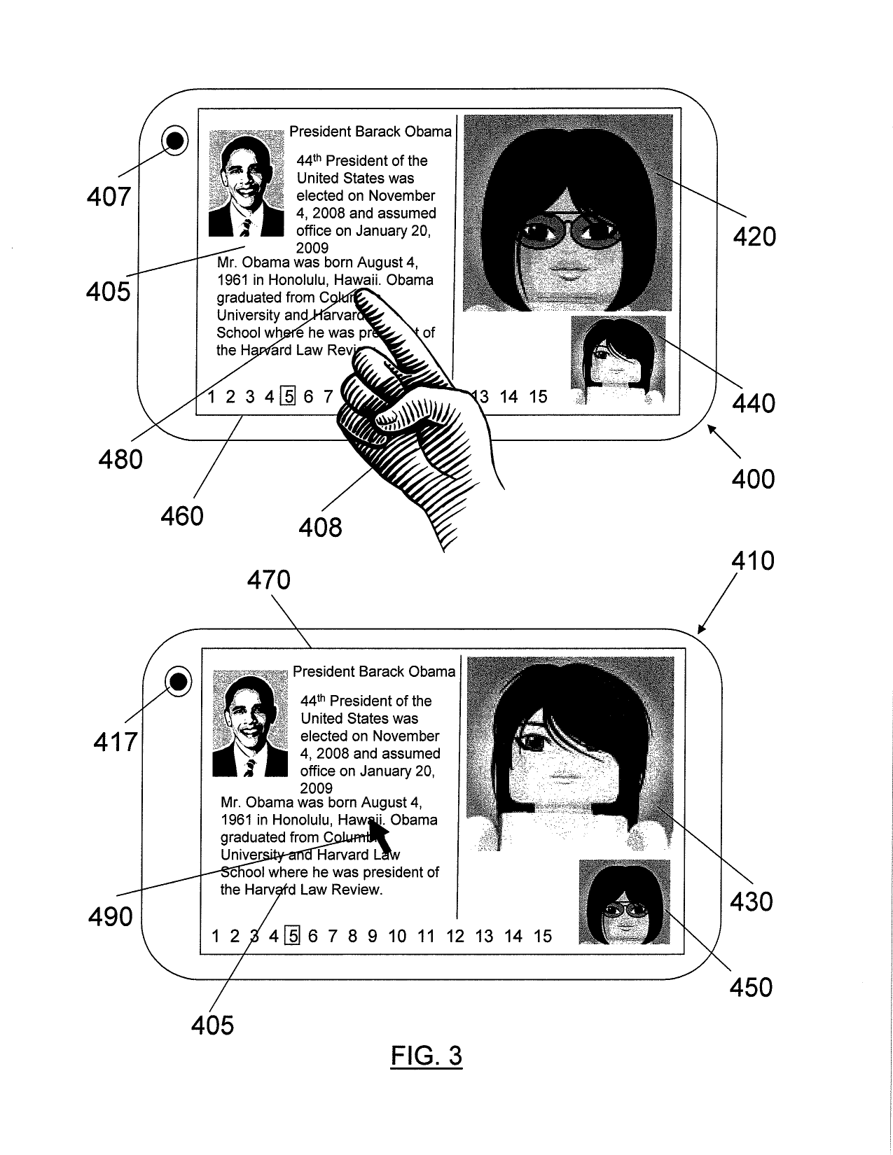

Example embodiments of the present invention may be particularly useful for families including a parent that is located remotely from a child as may be represented by the illustration of FIG. 3. The participating parties may include a parent with a first device 400 and a child with second device 410. Each of the first device 400 and the second device 410 may include content 405. In the illustrated embodiment, the content displayed 405 may be a page of a book. The content 405 is presented on a display of each respective device 460, 470. The first device 400 may present an image of the child 420 and an image of the parent 440. The image of the parent 440 may be shown smaller than the image of the child 420 as the parent may only wish to view the image of themselves to ensure they are captured properly in the frame of the camera 407. The images may be resized by a user according to the user's preferences. The device 410 of the child may present an image of the parent 430 and an image of the child 450. The image of the parent 430 may be provided by the device 400 of the parent as captured by a camera 407. While it is an image of the parent 430 that is illustrated in the example embodiment, the image displayed 430 (and 440) may be whatever the camera 407 captures. Similarly, the camera 417 of the child's device 410 may capture an image of the child 440 (and 450) and provide it to each device 400, 410 for display.

FIG. 3 further depicts a hand 408 which may be the hand of the parent. The hand of the parent 408 may point to and touch the display 460 of the parent's device 400 at 480 of the displayed content 405. In response, the child's device 410 may then present a cursor or pointing device 490 at the corresponding location on the content 405 of the child's device display 470. This may be beneficial to a parent reading to a child and pointing to the words as they are read to help the child to recognize and read words or pointing to images on a page. Although not shown, the pointing device 490 may also be displayed on the parent's device 400 in response to the hand of the parent 408 touching the display 460 at 480. This may allow the parent to view exactly what is presented on the display of the child's device in an effort to avoid confusion regarding what the child may be viewing on the display 470 of their device 410.

While the illustrated examples have been directed to using a device, such as an E-reader to share content of books, it should be appreciated that a book as presented by an E-reader is merely a collection of images and any collection of images may be shared in this way. For example, photos, magazines, spreadsheets, or other image content. In an example embodiment displaying photo content, perhaps downloaded from a photo sharing website, the photographs may be displayed as a slide show with each photo being the equivalent of a page in a book. Thus, each participating party may view the photo and any party may advance to the next photo or point to specific aspects of the photo that is displayed as content. Additionally, the content displayed may also include streaming content such as a movie, webcam feed, or other video multi-media.

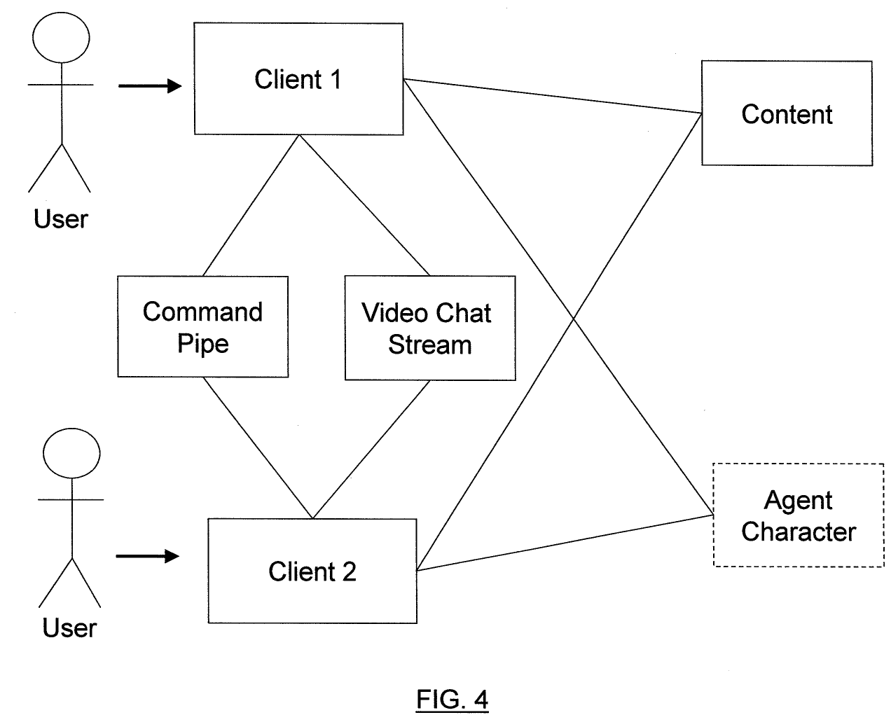

FIG. 4 depicts a block diagram of a system for implementing example embodiments of the present invention. Users or the participating parties interact with a client such as mobile terminal 10, depicted as Client 1 and Client 2 respectively, to view content. The content may be provided by a network client, such as a server or web server, or the content may be provided by one of the Clients for display on another Client. The Command Pipe provides a real-time communication channel to synchronize content between Client 1 and Client 2. The Command Pipe will provide the command to Client 2 to turn the page when the user of Client 1 directs a page to be turned. The content may further include a pointing device generated when a user points to an area of the content. The Command Pipe ensures that the content displayed on a first Client is substantially the same as the content displayed on other Clients of participating parties or users. The Video Stream may provide video between Client 1 and Client 2 and may also provide audio between the clients.

The content as viewed on the device of each participating party may be viewed and changed with low latency between content changes on the device. Such low latency may be achieved through synchronous streaming and buffering of the content to be displayed. Once the content is buffered at each device, the content synchronization between the devices of the participating parties may be achieved through the transmission and reception of content state messages which would require relatively small bandwidth and achieve rapid transmission times.

As noted above, the participating parties may, in some embodiments, be a parent and a child. In such an embodiment, it may be desirable for the parent and child to each use a single account through which the content may be shared. Such a shared account model may be different from traditional mobile subscriber accounts as the users sharing a single account may be assigned different levels of functionality that are associated with their respective devices. For example, in an account where one user is a child and one user is a parent, the portion of the account associated with the child user may not enable the device of the child to perform all of the functions that may be available on the portion of the account associated with the parent. The parent's device may include the functionality to initiate a shared-content session including a video and audio stream while the child's device may have this functionality inhibited, at least temporarily. The functionality change may be presented only as a change in the inputs available to a participant on the display of their device. For example, the child's device may not have a virtual key on a touch screen to “call” or “hang up” while the parent's device may include these virtual keys. Such a shared account model may provide a simpler mechanism for specific uses of embodiments of the present invention such as initiating a parent-child shared content session. This shared account model may also remove many of the technical complexities of calling, authenticating, and handshaking between devices.

While the above described embodiments may provide a shared, collaborative experience in viewing and interacting with content, further embodiments may enhance the shared content experience between the participating parties.

Static ebooks or books configured for display on electronic devices, such as E-readers, may not take advantage of video displays capable of animation and dynamic display of movement. As such, static ebooks lack the user engagement of video content such as movies and games. Since reading is a fundamental skill, it may be desirable to enhance the reading experience to encourage reading in lieu of watching a movie or playing video games. Since child engagement with books and static ebooks may be limited for some children, it may be desirable to enhance ebooks using the capabilities of the display to increase child engagement.

Adding an interactive animated character to the display of a static ebook may improve child engagement and enhance the reading experience. Adding dynamic content, such as an animated character in front (relative to the perspective of the user) of the presentation of a static content, such as a page image of an ebook may provide the appearance that the ebook is in an underlying relationship with the animated character. On small screen devices, compositing the character in front of the book may allow the character content to be included with static content without requiring more screen space or changing the aspect ratio of existing ebook software. Thus, the animated character provides an advantageous technique of adding interactivity to static ebooks.

According to example embodiments, the dynamic content, such as an interactive character, may be scripted to read a story to a user, for instance allowing audio ebooks to be read by a known, familiar character, such as a character from the book (e.g., the character may be Elmo reading a Sesame Street® book). Optionally, characters may be scripted to ask questions of the reader prompting thought and conversation about the book. Characters may provide additional information beyond what is included in the book, such as background on a particular character introduced in the book or facts pertaining to a point-of-interest featured in the book. The animated character may further be configured to ask pointed questions to the child or the parent which may aid the parent in initiating discussions and helping the child's understanding of the book.

Live action video footage of an animated character may be used as display elements of a software program. The animated character may guide the user through interface actions such as making a phone call or video call to establish the communications session. Further, the animated character may provide programmic feedback to the user, such as asking the user questions about content being viewed or read. The animated character may be an element of the user interface and represent software state by speaking and visually providing queues to the user. In an example embodiment, a single animation may provide a variety of live action video footage of the animated character such that different software states may cause different portions of the animation to be played which are indicative of the software state.

Pre-programmed characters which recite a limited number of phrases repeatedly may cause the reader to become fatigued with the repetition and to lose interest in the character and/or book. Example embodiments of the present invention may provide simple controls to a user such that the character can be made to seem “alive” and responsive to the input. Example embodiments of inputs may include: Talk, Yes, No, Laugh, etc. These inputs may be accessed by a touch of the character, the depression of a key that is part of the device's user input, such as the user interface of mobile terminal 10, or though voice recognition by the device which may interpret the reader's voice to be an input command. The character may be configured to ask questions of the user that require answers corresponding to one or more of the inputs. For example, the animated character may ask the reader if they are ready to turn the page. If the reader response with a “Yes” input, the page may be advanced. If the reader responds with a “No” input, the page may not be turned. The character may also be configured to perform “idle” movements between interactions with the ebook or the reader. Idle movements may include movements such as turning between looking at the reader and looking at the page image and/or acting as if the character is listening to the book being read. Idle movements may also include movements that correspond with scenes of a book, for example the character may yawn in response to a portion of the book intended to occur at night.

The dynamic content (e.g., an animated character) may include a dynamic content response that is presented on the display in response to a user input which may include answering a question, turning the page of a book, or pausing for more than a predetermined period of time on a page. The dynamic content may be selected from a look-up table where the look-up table may include dynamic content responses to a variety of user inputs, dynamic content responses based upon the content of the static content (e.g., ebook page) displayed, or other factors. In some embodiments, the dynamic content response may be selected randomly from available dynamic content responses. For example, when an animated character is “idle” or not required to respond to a change in static content or an input from a user, the “idle” dynamic content response may be randomly selected from available “idle” responses. Examples of idle responses may include a character swaying, pacing, looking around, falling asleep, etc. Further, the dynamic content response may be selected deterministically. The methods to deterministically select the dynamic content response may include sequentially, based on a frequency assigned to each response (i.e., those with higher frequencies get selected more frequently than those with lower frequencies), based on a characteristic of the dynamic content response, or other methods that otherwise determine the dynamic content response to be selected.

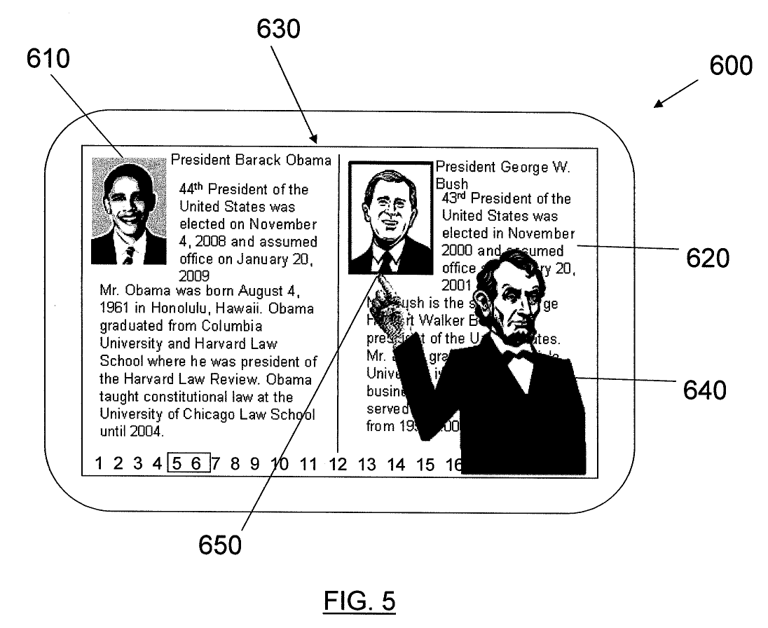

An example embodiment of dynamic content appearing in front of static content is illustrated in FIG. 5 which includes an animated character appearing in front of the pages of an ebook. The device 600 includes a display 630 presenting two pages 610, 620 of a book. An animated character 640 is superimposed over the images of the pages 610, 620 and may be configured to interact with a reader as described above. In the instant embodiment, the animated character 640 is pointing 650 to a portion of the page 620, perhaps as the animated character is explaining details around the subject matter of the page or asking the reader questions.

Embodiments of the invention featuring an animated character appearing in front of a page of an ebook may be implemented by superimposing an animation of the character with a transparent background over the pages of an ebook, giving the appearance that the character is floating in front of the pages. The character may be created to have a persistent presence in front of the book pages such that turning the pages behind the character does not change the representation of the character itself. Further, the character may have a sense of being alive by constantly displaying animation of the character standing, moving slightly, sniffling, or performing other “idle” behaviors. Additionally, a reader may touch or click on the character to elicit a response from it, for example, making it laugh, wave, or talk about the book they are reading. The character may be configured to ask questions relating to the content of the book and the character may be configured to respond to answers to the questions.

As noted above, the character may be rendered on a transparent background and displayed in front of static ebook pages by, for example, processor 20 of mobile terminal 10. In a preferred embodiment, live action video footage of the character may be shot on a green-screen background, which may later be keyed out by image processing. The resulting footage of the character with the transparent background may be rendered on with a transparent alpha layer background in a codec (e.g. VP6a) which supports compression and transparency. This footage may be composited in front of the ebook pages by, for example, processor 20 of mobile terminal 10, during runtime on, for example, display 28. For platforms which do not support transparency codecs, the alpha layer can be rendered next to the image in a single video and keyed out on a frame-by-frame basis during runtime. Characters may also be animated by computer graphics programs or by manual animation with drawings or cells.

The dialog provided by the character via, for example speaker 24, may be preprogrammed such that the dialog and actions of the character may be randomly retrieved or chosen based on a lookup table with comments that correspond to the book pages being read. Such a lookup table may be stored in memory, such as memory 42 of mobile terminal 10. If the character is touched or the character is otherwise requested to become interactive by the user interface (e.g., a touch screen or keypad 30) and there is no content available for the current page, the character may be made to respond with generic comments or non-conversational reactions such as waving, dancing, or laughing. A series of buttons may correspond to different responses from the character. For example touching the character's body may elicit non-conversational responses such as a laugh when the belly of the character is touched. Touching “yes” may cause the character to say yes or elicit a positive response while touching “no” may cause the character to say no or elicit a negative response. These buttons may be used by the parent to make it seem as if the character is responding to their questions. For example the parent might ask the character, “Are you ready to hear a story?”, then click the “yes” button to elicit a positive response from the character. As noted above, the inputs may be standard graphical user interface buttons on a touch screen, invisible hotspots on the display, or physical keys on the perimeter of the device.

Example embodiments of an interactive animated character may require or benefit from a segue between active interaction with a reader and non-active, idle behaviors. Such a segue may be managed in a number of ways; however, a preferred embodiment may include idle scenes being created with a medium framing of the character, while dialogue may be framed with a close or tight framing. The segue may be achieved by a “jump cut” where the video instantly transitions from the medium shot to the tight shot when the character transitions from idle to interactive. This segue may give the impression that the character is coming closer to the user when the character is made to speak or otherwise interact with a reader.

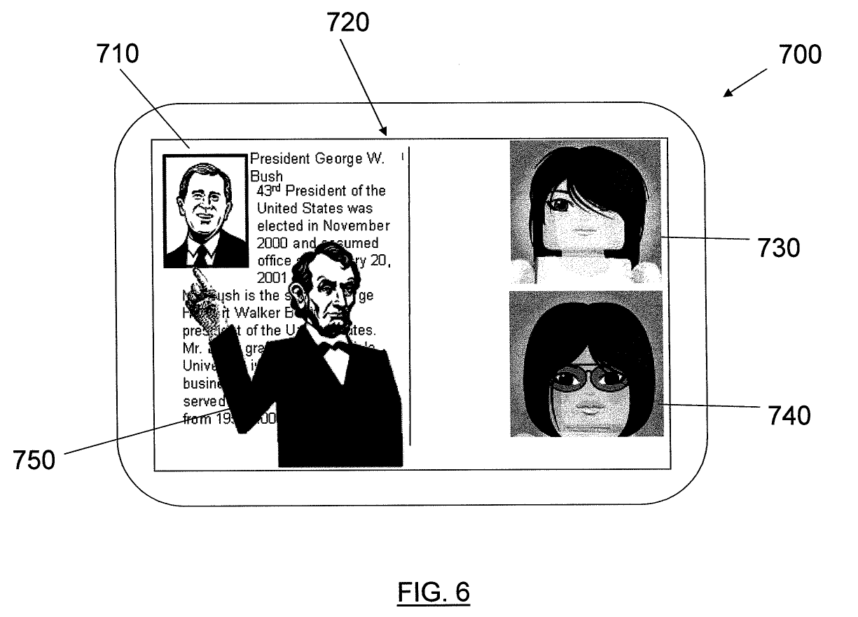

The animated character may be combined with the shared viewing experience outlined above to create an interactive experience that may be viewed by multiple participating parties. FIG. 6 illustrates an example embodiment wherein a device 700 with a display 720 is configured to present content 710 to a participating party. Another participating party may view the same content on another device. A video of the local participating party may be displayed 730 and a video of the remote participating party may also be displayed 740. An interactive animated character 750 may be displayed in front of the page or content 710 as described above. In the illustrated embodiment, each of the participating parties may view the same content and the same animated character superimposed over the content. Any of the participating parties may be able to interact with the animated character 750 and the animated character's response may be viewed by all participating parties.

Referring back to FIG. 4, the block diagram also illustrates an agent character which may be configured to provide the animated character content to both clients. The animated character may be generated in the character agent from data stored on either or both of the clients (e.g., in memory 42 of mobile terminal 10) or the data may be stored on a remote server or network which is accessed by one or more of the clients.

In an example embodiment, prior to the initiation of a shared content session, the animated character presented on a user's device may provide assistance in navigating through the available software options. For example, if a child turns on an electronic reading device or initiates a shared-content program, the animated character may react to the local input and ask the child user: “Who do you want to read with today?” The child may be offered a selection of remote users through, for example, a series of pictures on a touch screen, which may include the users of the shared account as outlined above. The child may select a picture of their parent to initiate a shared content session with that parent. When the shared content session is established, the animated character may respond positively with an animated clip of the character saying “hooray, we're all going to read together!”

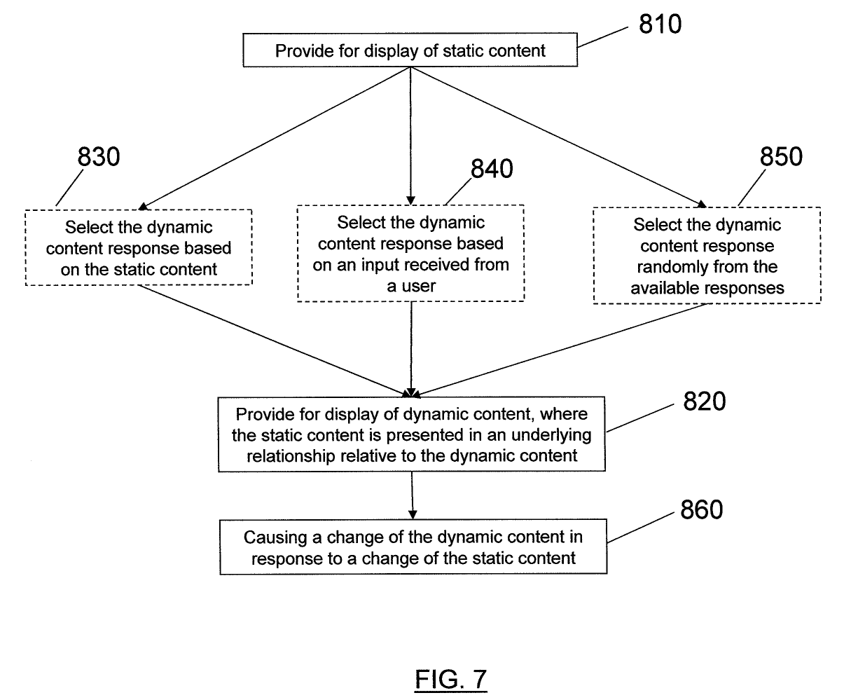

FIG. 7 is a flowchart of a technique according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device (e.g., memory 42) of a user device such as mobile terminal 10 and executed by a processor 20 in the user device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, an apparatus according to one embodiment of the invention, as shown in FIG. 7, may include means, such as the processor 20, display 28, or the like, for providing for display of static content at 810 and providing for display of dynamic content at 820. The static content may be presented in an underlying relationship relative to the dynamic content from the perspective of the user. The static content may be presented in an underlying relationship relative to the dynamic content. The apparatus may further include means to cause a change of the dynamic content in response to a change in the static content at 860.

In some embodiments, certain ones of the operations above may be modified or further amplified as described below. Moreover, in some embodiments additional optional operations may also be included as illustrated in FIG. 7 in broken lines. It should be appreciated that each of the modifications, optional additions or amplifications below may be included with the operations above either alone or in combination with any others among the features described herein. In some embodiments, the apparatus may include means, such as the processor 20, for selecting the dynamic content response based on the static content at 830, selecting the dynamic content response based on an input received from a user at 840, or selecting the dynamic content response randomly from the available responses at 850. Optionally, the dynamic content response may be selected deterministically from the available responses.

As described above, an apparatus for performing the method of FIG. 7 above may comprise a processor (e.g., the processor 20) configured to perform some or each of the operations (810-860) described above. The processor 20 may, for example, be configured to perform the operations (810-860) by performing hardware implemented logical functions, executing stored instructions, or executing algorithms for performing each of the operations. Alternatively, the apparatus may comprise means for performing each of the operations described above. In this regard and as also described above, examples of means for performing operations 810-860 may comprise, for example, the processor 20.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
providing for display of static content;
providing for display of dynamic content, wherein the static content is presented in an underlying relationship relative to the dynamic content, wherein the dynamic content is responsive to a user input; and
causing a change of the dynamic content in response to a change of the static content.

2. The method of claim 1, wherein the dynamic content comprises a dynamic content response and wherein the dynamic content response is selected from a plurality of available dynamic content responses.

3. The method of claim 2, further comprising selecting the dynamic content response from a look-up table based on the displayed static content.

4. The method of claim 2, further comprising selecting the dynamic content response from a look-up table based on an input received from a user.

5. The method of claim 2, further comprising selecting the dynamic content response randomly from the plurality of available dynamic content responses.

6. The method of claim 1, wherein the static content comprises an image of a page of a book.

7. The method of claim 6, wherein the dynamic content comprises an animated character configured to read the page of the book

8. An apparatus comprising at least one processor and at least one memory including computer program code, the at least one memory and the computer program code configured to, with the processor, cause the apparatus to at least:
provide for display of static content;
provide for display of dynamic content, wherein the static content is presented in an underlying relationship relative to the dynamic content, wherein the dynamic content is responsive to a user input; and
cause a change of the dynamic content in response to a change of the static content.

9. The apparatus of claim 8, wherein the dynamic content comprises a dynamic content response and wherein the dynamic content response is selected from a plurality of available dynamic content responses.

10. The apparatus of claim 9, wherein the apparatus is further caused to select the dynamic content response from a look-up table based on the displayed static content.

11. The apparatus of claim 9, wherein the apparatus is further caused to select the dynamic content response from a look-up table based on an input received from a user.

12. The apparatus of claim 9, wherein the apparatus is further caused to select the dynamic content response randomly from the plurality of available dynamic content responses.

13. The apparatus of claim 8, wherein the static content comprises an image of a page of a book.

14. The apparatus of claim 13, wherein the dynamic content comprises an animated character configured to read the page of the book.

15. A computer program product comprising at least one non-transitory computer-readable storage medium having computer-executable program code instructions stored therein, the computer-executable program code instructions comprising program code instructions to:
provide for display of static content;
provide for display of dynamic content, wherein the static content is presented in an underlying relationship relative to the dynamic content, wherein the dynamic content is responsive to a user input; and
cause a change of the dynamic content in response to a change of the static content.

16. The computer program product of claim 15, wherein the dynamic content comprises a dynamic content response and wherein the dynamic content response is selected from a plurality of available dynamic content responses.

17. The computer program product of claim 16, further comprising program code instructions to select the dynamic content response from a look-up table based on the displayed static content.

18. The computer program product of claim 16, further comprising program code instructions to select the dynamic content response from a look-up table based on an input received from a user.

19. The computer program product of claim 16, further comprising program code instructions to select the dynamic content response randomly.

20. The apparatus of claim 8, wherein the static content comprises an image of a page of a book and wherein the dynamic content comprises an animated character configured to read the page of the book.
